(19) United States
(12) Patent Application Publication
(10) Pub. No.: US 2012/0187708 A1
(43) Pub. Date: Jul. 26, 2012

(54) Police cruiser shield apparatus and method

(76) Inventor: Mark White, Houston, TX (US)

(21) Appl. No.: 12/286,860

(22) Filed: Oct. 1, 2008

Related U.S. Application Data
(60) Provisional application No. 60/997,151, filed on Oct. 1, 2007.

(51) Int. Cl. B60P 3/00; B23P 17/00

(52) U.S. Cl. 296/24.46; 29/527.1

(57) ABSTRACT

The protective shield apparatus comprises a partition, a collar, a plurality of protrusions, a plurality of securing members. The partition is provided to fill a surface area between the two volumes to be divided, such as, for example, the front seat area and the back seat area. The perimeter of the surface area is engaged by the collar for completely securing the two volumes. The protrusions are fixedly engaged with the collar. Further, the protrusions in operative association with the abutment secure the protective shield apparatus in place. Particularly, the protrusions and the abutment secure a member on alternate sides for securing the protective shield apparatus. The partition can be comprised of multiple sheets of partitions. The multiple sheets of partition are held together by a plurality of securing members. Thus, the protective shield apparatus can be adapted for varying levels of protection by adding another partition and securing the partitions together with the securing members. Optionally, the protective shield apparatus also comprises a window frame and a window. The window is secured in the window frame. All the materials used in the protective shield apparatus have a specific ballistic certification. The method provides for injecting woven roving ballistic grade fiberglass cloth with a thermoset polyester resin to form impregnated cloth, placing the impregnated cloth in a hot press, pressing the impregnated cloth into flat rigid sheets and other shapes, fabricating components from the pressed impregnated cloth such as partitions, window frames, collars, protrusions, abutments, and assembling the components into a protective shied apparatus.

### CROSS REFERENCE TO RELATED APPLICATION

The present application is a continuation-in-part application of the application of Mark White, U.S. Ser. No. 60/997,151, filed Oct. 1, 2007, entitled Police Cruiser Shield Apparatus and Method.

### FIELD OF THE INVENTION

The present invention relates generally to the protection of police officers in police cruisers or vehicles. The present invention relates generally to a protective shield and method for use with a police cruiser or vehicles. Further, the present invention relates to a shield apparatus and associated method that provides protection for the police officer in the cruiser or vehicle.

### BACKGROUND OF THE INVENTION

There is a great need for fixtures in police cruisers and vehicles to protect the officers in the cruiser or vehicle. These devices are typically either steel devices that are functionally difficult to use or are plastic devices that are not sufficient to protect the officer in the cruiser or vehicle.

For example, prior art devices may be constructed from 14-gauge steel and framed with 1-2″ structural tubing. Such devices are bulky and functionally difficult to use. Further, such prior art devices are inherently unsafe. If a weapon is discharged in the vicinity of such a prior art device, the bullet would ricochet from the prior art device and provide a death-threatening environment for anyone in the vicinity.

Alternately, prior art devices can have 11-gauge, expanded metal with a vinyl-coated expanded metal screen window or a half acrylic plastic, half vinyl-coated expanded metal window. However, the known devices are rigidly made resulting in a life-threatening environment due to ricochet, or are not sufficient to provide protection to the officer in the first place.

It would be advantageous to have a protective shield apparatus for use in police cruisers and vehicles that provides safety to the officer, is structurally sound, and does not provide a life-threatening environment due to ricochet.

It is, therefore, a feature of the present invention to provide a protective shield apparatus that provides a safety barrier to a police officer in a cruiser or vehicle.

Another feature of the present invention is to provide a protective shield apparatus for engagement with a conventional police cruiser or vehicle.

Another feature of the present invention is to provide a protective shield apparatus for providing security between the front seat and the back seat of the police cruiser.

Still another feature of the present invention is to provide a protective shield apparatus for providing security between the front seat and the windshield of a police cruiser.

Yet another feature of the present invention is to provide a protective shield apparatus for providing security between the occupants and the doors of a police cruiser.

Yet still another feature of the present invention is to provide a protective shield apparatus for providing security between the occupants and the windows of the doors of a police cruiser.

Another feature of the present invention is to provide a protective shield apparatus for engagement with a conventional police cruiser or vehicle that is a lightweight bullet resistant barrier.

Still another feature of the present invention is to provide a protective shield apparatus for engagement with a conventional police cruiser or vehicle that is easily fabricated, cut and drilled using ordinary carpentry tools.

Another feature of the present invention is to provide a protective shield apparatus for engagement with a conventional police cruiser or vehicle that delaminates and absorbs a projectile upon impact.

Still another feature of the present invention is to provide a protective shield apparatus for engagement with a conventional police cruiser or vehicle that prevents the dangerous ricochet of a projectile.

Another feature of the present invention is to provide a protective shield apparatus for engagement with a conventional police cruiser or vehicle that is only a fraction of the weight of steel armor.

Additional features and advantages of the invention will be set forth in part in the description which follows, and in part will become apparent from the description, or may be learned by practice of the invention. The features and advantages of the invention may be realized by means of the combinations and steps particularly pointed out in the appended claims.

### SUMMARY OF THE INVENTION

To achieve the foregoing objects, features, and advantages and in accordance with the purpose of the invention as embodied and broadly described herein, a seat-platform apparatus and method is provided.

The protective shield apparatus comprises a partition, a collar, a plurality of protrusions, a plurality of securing members. The partition is provided to fill a surface area between the two volumes to be divided, such as, for example, the front seat area and the back seat area. The perimeter of the surface area is engaged by the collar for completely securing the two volumes. The plurality of protrusions are divided into three categories: a small protrusion, an intermediate protrusion and an elongate protrusion. The protrusions are fixedly engaged with the collar. Further, the protrusions in operative association with the abutment secure the protective shield apparatus in place. Particularly, the protrusions and the abutment secure a member on alternate sides for securing the protective shield apparatus. The partition can be comprised of multiple sheets of partitions. The multiple sheets of partition are held together by a plurality of securing members. Thus, the protective shield apparatus can be adapted for varying levels of protection by adding another partition and securing the partitions together with the securing members. Optionally, the protective shield apparatus also comprises a window frame and a window. The window frame is secured to the partition with a plurality of securing members. The window is secured in the window frame. All the materials used in the protective shield apparatus have a specific ballistic certification.

The protective shield apparatus of the present invention can be a partition protective shield apparatus, a windshield protective shield apparatus, a door protective shield apparatus, and a window protective shield apparatus. However, it can be appreciated by those skilled in the art that many and varied uses for the protective shield apparatus are possible.

The material preferred for use in the protective shield apparatus 100 is a bullet resistant fiberglass that is a fiberglass reinforced plastic. The material is manufactured by mechanically injecting woven roving ballistic grade fiberglass cloth with a thermoset polyester resin. The impregnated cloth is then placed in a hydraulic hot press and pressed into flat rigid sheets. The flat rigid sheets comprise the partitions , the window frame, the protrusions and the abutment. The material is a bullet resistant fiberglass for virtually any area requiring a lightweight bullet resistant barrier.

Additional advantages and modification will readily occur to those skilled in the art. The invention in its broader aspects is therefore not limited to the specific details, representative apparatus, and the illustrative examples shown and described herein. Accordingly, the departures may be made from the details without departing from the spirit or scope of the disclosed general inventive concept.

### BRIEF DESCRIPTION OF THE DRAWINGS

The accompanying drawings which are incorporated in and constitute a part of the specification, illustrate a preferred embodiment of the invention and together with the general description of the invention given above and the detailed description of the preferred embodiment given below, serve to explain the principles of the invention.

FIG. 1 is a perspective view of a protective shield apparatus of the present invention for use as a partition between the front seat and the back seat of a police cruiser or vehicle.

FIG. 2 is a flow chart illustrating various uses of the protective shield apparatus of the present invention.

FIG. 3 is a flow chart illustrating a preferred method of making the material used in the protective shield apparatus of the present invention.

FIG. 4 is a perspective view of another embodiment of the protective shield apparatus of the present invention for use in association with another partition between the front seat and the back seat of a police cruiser or vehicle.

The above general description and the following detailed description are merely illustrative of the generic invention, and additional modes, advantages, and particulars of this invention will be readily suggested to those skilled in the art without departing from the spirit and scope of the invention.

### DETAILED DESCRIPTION OF THE PREFERRED EMBODIMENTS

Reference will now be made in detail to the present preferred embodiments of the invention as described in the accompanying drawings.

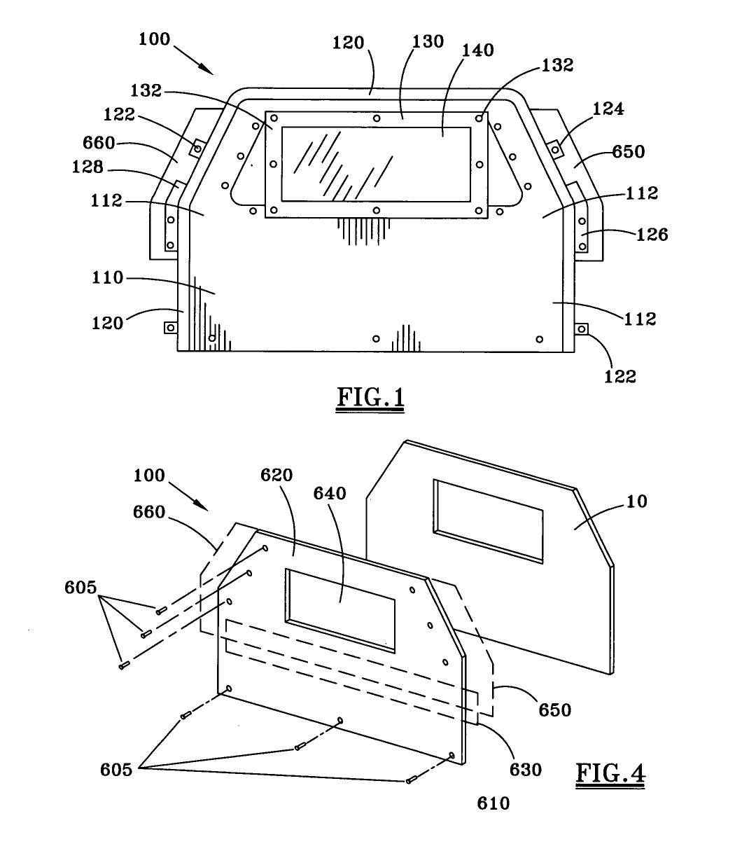

FIG. 1 is a perspective view of a protective shield apparatus of the present invention for use as a partition between the front seat and the back seat of a police cruiser or vehicle. The protective shield apparatus 100 comprises a partition 110, a collar 120, a plurality of protrusions 122, 124, 126, a plurality of securing members 112. The partition 110 is provided to fill a surface area between the two volumes to be divided, such as, for example, the front seat area and the back seat area. The perimeter of the surface area is engaged by the collar 120 for completely securing the two volumes. The plurality of protrusions 122, 124, 126 are divided into three categories: a small protrusion 122, an intermediate protrusion 124 and an elongate protrusion 126. The protrusions are fixedly engaged with the collar 120. Further, the protrusions 122, 124, 126 in operative association with the abutment 128 secure the protective shield apparatus 100 in place.

Particularly, the protrusions 122, 124, 126 and the abutment 128 secure a member (not illustrated) on alternate sides for securing the protective shield apparatus 100. The partition 110 can be comprised of multiple sheets of partitions 110. The multiple sheets of partition 110 are held together by a plurality of securing members 112. Thus, the protective shield apparatus 100 can be adapted for varying levels of protection by adding another partition 110 and securing the partitions 110 together with the securing members 112.

Optionally, the protective shield apparatus 100 also comprises a window frame 130 and a window 140. The window frame 130 is secured to the partition 110 with a plurality of securing members 132. The window 140 is secured in the window frame 130. All the materials used in the protective shield apparatus 100 have a specific ballistic certification.

FIG. 2 is a flow chart illustrating various uses of the protective shield apparatus 100 of the present invention. The flow chart illustrates the partition protective shield apparatus 100, a windshield protective shield apparatus 200, a door protective shield apparatus 300, and a window protective shield apparatus 400. However, it can be appreciated by those skilled in the art that many and varied uses for the protective shield apparatus 100 are possible.

FIG. 3 is a flow chart illustrating a preferred method of making the material used in the protective shield apparatus of the present invention. The material preferred for use in the protective shield apparatus 100 is a bullet resistant fiberglass that is a fiberglass reinforced plastic. The material is manufactured by mechanically injecting woven roving ballistic grade fiberglass cloth with a thermoset polyester resin. The impregnated cloth is then placed in a hydraulic hot press and pressed into flat rigid sheets. The flat rigid sheets comprise the partitions 110, the window frame 130, the protrusions 122, 124, 126 and the abutment 128. The material is a bullet resistant fiberglass for virtually any area requiring a lightweight bullet resistant barrier. The material can be cut and drilled using ordinary carpentry tools. The material delaminates and absorbs the projectile if attacked, unlike steel armor that would cause a dangerous ricochet. The material reduces labor costs because it is only a fraction of the weight of steel armor. The material also carries independent ballistic certification.

Testing is conducted in accordance with U.L. 752, N.I.J. 0108101, or U.S. State Department Standards. The material is approved by the U.S. Marshal Service.

Generally, the method provides for injecting woven roving ballistic grade fiberglass cloth with a thermoset polyester resin to form impregnated cloth, placing the impregnated cloth in a hot press, pressing the impregnated cloth into flat rigid sheets and other shapes, fabricating components from the pressed impregnated cloth such as partitions, window frames, collars, protrusions, abutments, and assembling the components into a protective shied apparatus.

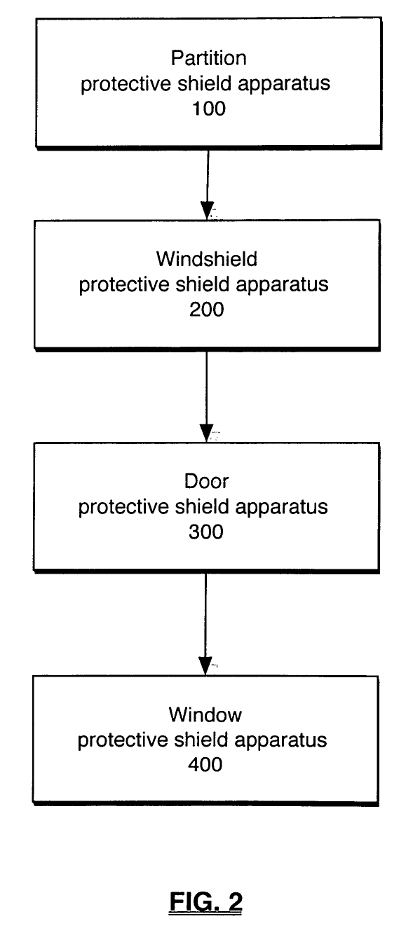

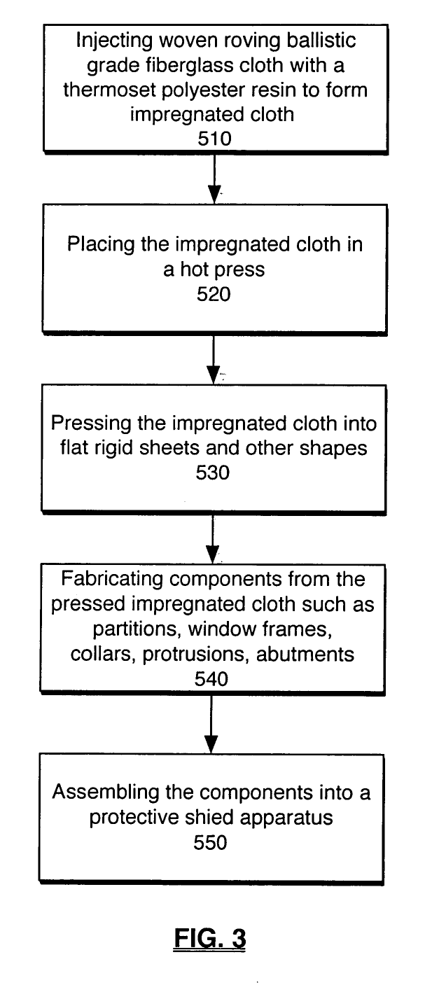

FIG. 4 is a perspective view of another embodiment of the protective shield apparatus 600 of the present invention for use in association with a standard partition 10 between the front seat and the back seat of a police cruiser or vehicle. The protective shield apparatus 600 comprises a first panel and a second panel 620. The first panel and the second panel 620 are secured by one or more securing members 605. The securing members 605 can be any appropriate device such as screws, bolts, rivets and the like. The first panel 610 and the second panel 620 are fixedly engaged. The intermediate panel 630 is placed so as to cover the interface between the first panel 610 and the second panel 620. The intermediate panel 630 conceals the seam or interface between the first panel 610 and the second panel 620.

A first sidewing panel 650 is attached to the second panel 620. Also, a second sidewing panel 660 is attached to the second panel 620. Alternately, the first sidewing panel 650 and the second sidewing panel 660 are attached to the second panel 620 and a portion of the first panel 610. The arrangement of the first panel 610, the second panel 620, the first sidewing panel 650 and the second sidewing panel 660 is determined by the structure into which it is being placed. A unique feature is that the first panel 610, the second panel 620, the first sidewing panel 650 and the second sidewing panel 660 are in an overlapping relationship so as to prevent any penetration from a projectile. A window unit 640 is adapted to be placed in the second panel 620. The window unit 640 comprises brackets and securing members.

Additional advantages and modification will readily occur to those skilled in the art. The invention in its broader aspects is therefore not limited to the specific details, representative apparatus, and the illustrative examples shown and described herein. Accordingly, the departures may be made from the details without departing from the spirit or scope of the disclosed general inventive concept.

What is claimed is:

1. A protective shield apparatus for use as a space partition comprising:
(a) a partition,
(b) a collar,
(c) a plurality of protrusions, and
(d) a plurality of securing members,
such that the perimeter of the surface area is engaged by the collar for completely securing two volumes with the plurality of protrusions fixedly engaged with the collar and the protrusions in operative association with the abutment to secure the protective shield apparatus in place such that the protrusions and the abutment secure a remote member on alternate sides for securing the protective shield apparatus thereto.

2. A method of manufacturing a protective shield apparatus comprising the steps of:
(a) injecting woven roving ballistic grade fiberglass cloth with a thermoset polyester resin to form impregnated cloth,
(b) placing the impregnated cloth in a hot press,
(c) pressing the impregnated cloth into flat rigid sheets and other shapes,
(d) fabricating components from the pressed impregnated cloth such as partitions, window frames, collars, protrusions, abutments, and
(e) assembling the components into a protective shied apparatus.
